(19) United States
(12) Patent Application Publication
(10) Pub. No.: US 2023/0145718 A1
(43) Pub. Date: May 11, 2023

(54) Automatic Cocktail Making Device

(71) Applicant: ROSS (SHANGHAI) F&B CO., LTD., Shanghai (CN)

(72) Inventors: Yunhua Wang, Shanghai (CN); Jing Zhang, Shanghai (CN); Zehuang Hong, Shanghai (CN)

(21) Appl. No.: 17/791,320

(22) PCT Filed: Oct. 21, 2020
(86) PCT No.: PCT/CN2020/122449

§ 371 Date: Dec. 22, 2022

(30) Foreign Application Priority Data
Jan. 8, 2020 (CN) 202010016913.8
Jan. 8, 2020 (CN) 202020037601.0

(51) Int. Cl. C12G 3/04; A47J 43/042; A47J 43/08; B25J 11/00

(52) U.S. Cl. CPC C12G 3/04; A47J 43/042; A47J 43/08; B25J 11/0045

(57) ABSTRACT

The present invention provides an automatic cocktail making device including a clamping device connected to a mechanical arm, and a shaker body being connected to the clamping device. The clamping device is provided with a linear driving device, and an output end of the linear driving device is connected to a strainer lid by means of a connecting member, to drive the strainer lid to cover or move away from an opening of the shaker body. The automatic cocktail making device further includes a fixedly mounted cap hanging device. The cap is detachably connected to the cap hanging device, and the cap and the strainer lid are detachably connected to each other. The present invention has the following advantages: by providing the fixedly mounted cap hanging device, automatic, sealed and detachable connection between the cap and the strainer lid is achieved, and the linear driving device assists to drive the strainer lid to cover the shaker body, thereby improving the sealing performance and automation degree of the whole cocktail making device.

### CROSS-REFERENCE TO RELATED APPLICATIONS

This application is the United States national phase of International Application No. PCT/CN2020/122449 filed Oct. 21, 2020, and claims priority to Chinese Patent Application Nos. 202010016913.8 filed Jan. 8, 2020 and 202020037601.0 filed Jan. 8, 2020, the disclosures of which are hereby incorporated by reference in their entirety.

### BACKGROUND OF THE INVENTION

### Field of the Invention

The present invention relates to the technical field of food instruments, and in particular, to an automatic cocktail making device.

### Description of Related Art

Currently, most of the automatic cocktail making devices on the market use a mechanical arm to drive a cocktail shaker to shake, so that liquid in the cocktail shaker is evenly mixed. However, during cocktail making process, problems such as poor sealing performance of the cocktail shaker, which affects the taste of cocktail, easily occur. Moreover, a common three-piece cocktail shaker mainly comprises three parts: a cap, a strainer lid and a shaker body, wherein how to mount and remove a cap, and further improving the automation degree of an automatic cocktail making device while ensuring the sealing performance of a cocktail shaker, are also problems to be urgently solved.

### SUMMARY OF THE INVENTION

With regard to the described defects, the technical problem to be solved by the present invention is to provide an automatic cocktail making device, which can automatically complete the mounting and removing of a cap and ensure the sealing performance.

The present invention provides an automatic cocktail making device, comprising a clamping device connected to a mechanical arm, a shaker body being connected to the clamping device, characterized in that the clamping device is provided with a linear driving device, and an output end of the linear driving device is connected to a strainer lid by means of a connecting member, to drive the strainer lid to cover or move away from an opening of the shaker body; the automatic cocktail making device further comprises a fixedly mounted cap hanging device, wherein a cap is detachably connected to the cap hanging device, and the cap and the strainer lid are detachably connected to each other.

Preferably, the cap hanging device and the cap are magnetically connected to each other.

Preferably, the cap hanging device is provided with a rotation driving device, a first magnetic member is fixedly connected to an output shaft of the rotation driving device, the top of the cap is magnetically connected to the first magnetic member, and the cap is in threaded connection with the strainer lid.

Preferably, the first magnetic member is provided with a recessed portion, the top of the cap is provided with a protruding portion matching the recessed portion, and the recessed portion and the protruding portion are magnetically connected to each other.

Preferably, the cap hanging device is provided with a second magnetic member, and the top of the cap is magnetically connected to the second magnetic member; and a magnetic ring is provided at the bottom of the cap along the edge of an opening of the cap, and the magnetic ring is magnetically connected to the outer side of an opening of the strainer lid.

Preferably, the clamping device and the shaker body are fixedly connected to each other.

Preferably, the clamping device and the shaker body are movably connected to each other.

Preferably, the clamping device comprises a pair of clamping portions which can move relative to each other and are used for clamping the shaker body.

Preferably, a circle of holding groove is further provided on the periphery of the shaker body, and the holding groove is matched with the clamping portions.

Preferably, the connecting member is L-shaped, and has one end connected to the output end of the linear driving device and the other end fixedly connected to the strainer lid, and the middle part of the connecting member is hinged to the top of the clamping device.

The present invention has the following advantages: by providing the fixedly mounted cap hanging device, automatic and detachable connection between the cap and the strainer lid is achieved, and the linear driving device assists to drive the strainer lid to cover the shaker body, thereby improving the sealing performance and automation degree of the whole cocktail making device.

### BRIEF DESCRIPTION OF THE DRAWINGS

FIG. 1 is a schematic structural diagram of an automatic cocktail making device according to Embodiment I of the present invention;

FIG. 2 is an enlarged view of A in FIG. 1;

FIG. 3 is a schematic structural diagram of an automatic cocktail making device according to Embodiment II of the present invention;

FIG. 4 is a perspective view of a cap hanging device; and

FIG. 5 is a schematic structural diagram of a cap hanging device according to Embodiment III of the present invention.

### ILLUSTRATION TO REFERENCE SIGNS OF ELEMENTS

1 Mechanical arm

2 Cap hanging device

21 Rotation driving device

22 Fixed support

23 First magnetic member

231 Recessed portion

24 Second magnetic member

31 Cap

311 Protruding portion

32 Strainer lid

321 Strainer screen

33 Shaker body

331 Holding groove

4 Clamping device

41 Linear driving device

42 Connecting member

43 Fixing seat

44 Clamping portion

5 Container

### DESCRIPTION OF THE INVENTION

Hereinafter, specific embodiments of the present invention will be further described in detail with reference to the accompanying drawings. These embodiments are only used to illustrate the present invention, but not to limit the present invention.

In the illustration of the present invention, it should be noted that orientation or position relationships indicated by terms such as “upper”, “lower”, “top”, “bottom”, “inner”, “outer”, etc. are orientation or position relationships based on the accompanying drawings, are only used to facilitate the illustration of the present invention and to simplify the illustration, rather than indicating or implying that a device or element referred to must have a specific orientation, and be constructed and operated in the specific orientation, and therefore said terms cannot be understood as a limitation to the present invention.

In the illustration of the present invention, it should be noted that unless specified or limited otherwise, the terms “mount”, “connect to”, and “connecting” should be understood broadly, and for example, may be fixed connection, and may also be detachable connection, or integral connection; may be mechanical connection, and may also be electrical connection; and may be direct connection, and may also be indirect connection by means of an intermediate medium, and may also be interior communication between two elements. For a person skilled in the art, the specific meanings of the described terms in the present invention could be understood according to specific situations.

In addition, in the illustration of the present invention, unless otherwise specified, “a plurality of” means two or more.

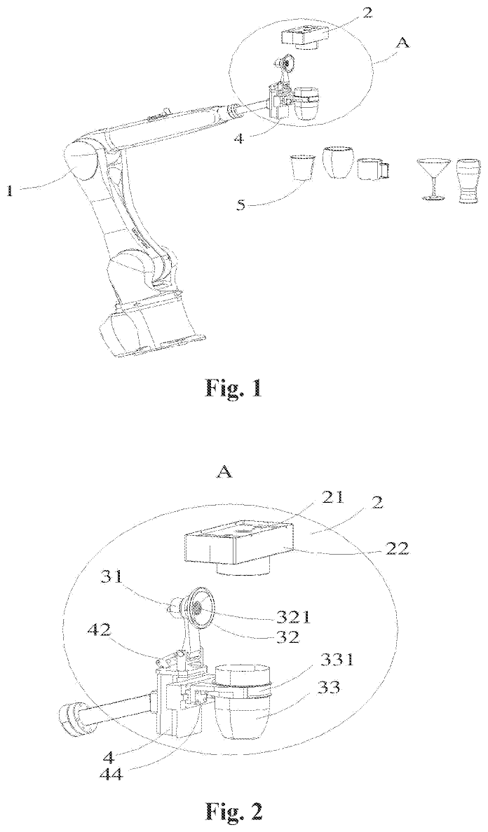

As shown in FIGS. 1-3, the present invention provides an automatic cocktail making device, the automatic cocktail making device comprising a clamping device 4 connected to a mechanical arm 1, a shaker body 33 of a cocktail shaker being connected to the clamping device 4, wherein the clamping device 4 is provided with a linear driving device 41, the linear driving device 41 is preferably a linear cylinder, and an output end of the linear driving device is connected to a strainer lid 32 by means of a connecting member 42, to drive the strainer lid 32 to cover or move away from an opening of the shaker body 33. Specifically, the connecting member 42 is L-shaped, and has one end connected to the output end of the linear driving device 41 and the other end fixedly connected to the strainer lid 32, and the middle part of the connecting member is hinged to the top of the clamping device 4. When the output end of the linear driving device 41 extends upward, the connecting member 42 is driven to drive the strainer lid 32 to move downward to cover the opening of the shaker body 33; and when the output end of the linear driving device 41 retracts downward, the connecting member 42 is driven to drive the strainer lid 32 to move upward and move away from the opening of the shaker body 33. A strainer screen 321 is provided in the strainer lid 32, and is used to filter a beverage inside the shaker body 33 in a pouring process.

As shown in FIGS. 2, 3 and 5, the automatic cocktail making device of the present invention further comprises a fixedly mounted cap hanging device 2, wherein a cap 31 is detachably connected to the cap hanging device 2, and the cap 31 is detachably connected to the strainer lid 32. Preferably, the cap hanging device 2 and the cap 31 are magnetically connected to each other, and the mechanical arm 1 can move after the cap 31 is connected to the strainer lid 32, so as to drive the cap 31 to be separated from the magnetic connection to the cap hanging device 2, thereby completing sealing of the cocktail making device. Of course, in addition to magnetic connection, a person skilled in the art may also provide a clamping device in the cap hanging device 2 according to needs; the clamping device clamps the cap 31, and the opening or closing of the clamping device is controlled by means of a control system, so as to achieve detachable connection between the cap 31 and the cap hanging device 2.

The following content relates to three specific embodiments of the present invention:

### Embodiment I

As shown in FIGS. 2-4, the cap hanging device 2 in Embodiment I comprises a rotation driving device 21 arranged in a fixed support 22, the rotation driving device 21 is preferably a stepper motor, and an output shaft of the rotation driving device is magnetically connected to a cap 31, and the cap 31 is in threaded fit with a strainer lid 32. Specifically, a first magnetic member 23 is fixedly connected to the output shaft of the rotation driving device 21, and the top of the cap 31 is magnetically connected to the first magnetic member 23. During operation, the linear driving device 41 drives the strainer lid 32 to cover the opening of the shaker body 33, and then the mechanical arm drives the strainer lid 32 and the shaker body 33 to move directly below the cap hanging device 2; in this case, the output shaft of the rotation driving device 21 drives, by means of the first magnetic member 23, the cap 31 to rotate, so that the cap 31 is tightly screwed on the strainer lid 32 below the cap. In this case, the mechanical arm further drives the strainer lid 32 and the shaker body 33 to move downward, and depending on a thread self-locking structure between the cap 31 and the strainer lid 32, the cap 31 is separated from the first magnetic member 23, thereby completing the mounting of the cap 31 on the cocktail shaker. When the cap 31 needs to be removed, it is only necessary to move the cap 31 to below the first magnetic member 23 again, so that the two are magnetically attached to each other, and then the output shaft of the rotation driving device 21 drives, by means of the first magnetic member 23, the cap 31 to rotate reversely, so that the cap 31 is separated from a threaded connecting portion of the strainer lid 32. In order to facilitate positioning, the first magnetic member 23 is provided with a recessed portion 231, the top of the cap 31 is provided with a protruding portion 311 matching the recessed portion 231, and the recessed portion 231 and the protruding portion 311 are magnetically connected to each other.

As shown in FIGS. 1 and 2, the clamping device 4 and the shaker body 33 are movably connected to each other. Specifically, the clamping device 4 comprises a sliding rail, two movable blocks are slidably connected to the sliding rail, one clamping portion 44 is fixed on each movable block, and the two clamping portions 44 can move relative to each other under the control of a control system; preferably, the clamping portions 44 are arc-shaped, and therefore can clamp the shaker body 33 or a common container 5 on the market, such as a goblet, a water cup or a tea cup, so as to transfer other beverages. In order to ensure the stability of clamping, a circle of holding groove 331 is further provided on the periphery of the shaker body 33, and the holding groove 331 is matched with the clamping portions 44, thereby effectively avoiding the occurrence of situations that the clamping portions 44 slip and the shaker body 33 falls off during cocktail making.

### Embodiment II

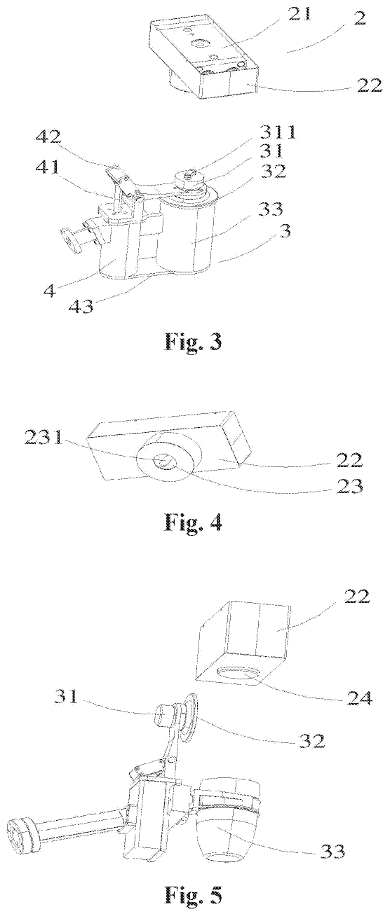

As shown in FIG. 3, the difference between Embodiment II and Embodiment I merely lies in that: the clamping device 4 and the shaker body 33 are fixedly connected to each other, specifically by means of several fixing seats 43, and the mechanical arm can drive, by means of the clamping device 4, the shaker body 33 to shake up and down, thereby completing cocktail making process.

### Embodiment III

As shown in FIG. 5, the differences between Embodiment III and Embodiment I lie in that: a second magnetic member 24 is directly provided in the cap hanging device 2 to replace the rotation driving device and the first magnetic member, the top of the cap 31 is magnetically connected to the second magnetic member 24, and a magnetic ring is provided at the bottom of the cap 31 along the edge of an opening of the cap, and the magnetic ring is magnetically connected to the outer side of an opening of the strainer lid 32. The magnetic force between the top of the cap 31 and the second magnetic member 24 is greater than the magnetic force between the magnetic ring at the bottom of the cap and the strainer lid 32. During operation, the linear driving device drives the strainer lid 32 to cover the opening of the shaker body 33, and then the mechanical arm drives the strainer lid 32 and the shaker body 33 to move directly below the cap hanging device 2, and in this case, the magnetic ring at the bottom of the cap 31 is magnetically connected to the outer side of the opening of the strainer lid 32, and the cap 31 is sleeved on the opening of the strainer lid 32 in a sealing manner. In this case, the mechanical arm further drives the strainer lid 32 and the shaker body 33 to move left and right, so that the top of the cap 31 is gradually separated from the second magnetic member 24, thereby completing the mounting of the cap 31 on the cocktail shaker. When the cap 31 needs to be removed, it is only necessary to move the cap 31 to below the second magnetic member 24, so that the two are magnetically attached to each other, and then the mechanical arm drives the strainer lid 32 and the shaker body 33 to move downward; as the magnetic force between the top of the cap 31 and the second magnetic member 24 is greater than the magnetic force between the magnetic ring at the bottom of the cap and the strainer lid 32, the cap 31 can be separated from the strainer lid 32.

In conclusion, the present invention has the following advantages: by providing the fixedly mounted cap hanging device, automatic, sealed and detachable connection between the cap and the strainer lid is achieved, and the linear driving device assists to drive the strainer lid to cover the shaker body, thereby improving the sealing performance and automation degree of the whole cocktail making device.

The contents above are only the preferred embodiments of the present invention. It should be pointed out that for a person skilled in the art, several improvements and replacements could also be made without departing from the technical principle of the present invention, and these improvements and replacements shall also fall within the scope of protection of the present invention.

1. An automatic cocktail making device, comprising a clamping device connected to a mechanical arm, a shaker body being connected to the clamping device, characterized in that the clamping device is provided with a linear driving device, and an output end of the linear driving device is connected to a strainer lid by means of a connecting member, to drive the strainer lid to cover or move away from an opening of the shaker body; the automatic cocktail making device further comprises a fixedly mounted cap hanging device, wherein a cap is detachably connected to the cap hanging device, and the cap and the strainer lid are detachably connected to each other.

2. The automatic cocktail making device according to claim 1, wherein the cap hanging device and the cap are magnetically connected to each other.

3. The automatic cocktail making device according to claim 2, wherein the cap hanging device is provided with a rotation driving device, a first magnetic member is fixedly connected to an output shaft of the rotation driving device, the top of the cap is magnetically connected to the first magnetic member, and the cap is in threaded connection with the strainer lid.

4. The automatic cocktail making device according to claim 3, wherein the first magnetic member is provided with a recessed portion, the top of the cap is provided with a protruding portion matching the recessed portion, and the recessed portion and the protruding portion are magnetically connected to each other.

5. The automatic cocktail making device according to claim 2, wherein the cap hanging device is provided with a second magnetic member, and the top of the cap is magnetically connected to the second magnetic member; and a magnetic ring is provided at the bottom of the cap along the edge of an opening of the cap, and the magnetic ring is magnetically connected to the outer side of an opening of the strainer lid.

6. The automatic cocktail making device according to claim 1, wherein the clamping device and the shaker body are fixedly connected to each other.

7. The automatic cocktail making device according to claim 1, wherein the clamping device and the shaker body are movably connected to each other.

8. The automatic cocktail making device according to claim 7, wherein the clamping device comprises a pair of clamping portions which can move relative to each other and are used for clamping the shaker body.

9. The automatic cocktail making device according to claim 8, wherein a circle of holding groove is further provided on the periphery of the shaker body, and the holding groove is matched with the clamping portions.

10. The automatic cocktail making device according to claim 1, wherein the connecting member is L-shaped, and has one end connected to the output end of the linear driving device and the other end fixedly connected to the strainer lid, and the middle part of the connecting member is hinged to the top of the clamping device.
